(19) United States
(12) Patent Application Publication
(10) Pub. No.: US 2005/0058413 A1
(43) Pub. Date: Mar. 17, 2005

(54) Light-absorbing surface and method

(76) Inventor: Peter Davis Poulsen, Grants Pass, OR (US)

Correspondence Address: MARTIN & ASSOCIATES, LLC, P O BOX 548, CARTHAGE, MO, 64836-0548, US

(21) Appl. No.: 10/925,774

(22) Filed: Aug. 25, 2004

Related U.S. Application Data
(60) Provisional application No. 60/497,748, filed on Aug. 26, 2003.

(51) Int. Cl. G02B 6/04

(52) U.S. Cl. 385/115

(57) ABSTRACT

A light-absorbing surface includes an array of elongated channels with openings at their proximal ends that face the light. These elongated channels may be straight, may include an angled portion, and may include two or more angled portions. The elongated channels may be suitably terminated at their distal end to further aid in absorbing light energy. The elongated channels may also be coated in a suitable coating that increases the specular reflectance of the elongated channels. The elongated channels act as specular reflector tubes that attenuate the light energy that enters in their proximal end with each bounce inside the channels. The result is a light-absorbing surface that absorbs almost all of the light directed at the light-absorbing surface. The elongated channels may also allow air flow through the light-absorbing surface.

### RELATED APPLICATION

This patent application claims the benefit of U.S. Provisional Application No. 60/497,748 entitled “ENERGY-ABSORBING SURFACE SYSTEM WITH CUMULATIVE REFLECTION COEFFICIENT BELOW THAT OF ITS COMPONENT SURFACE FINISHES AND METHOD FOR PRODUCING THE SAME”, filed on Aug. 26, 2003, which is incorporated herein by reference.

### BACKGROUND OF THE INVENTION

1. Technical Field

This invention generally relates to the field of energy-absorbing surfaces, and more specifically relates to light-absorbing surfaces.

2. Background Art

There are many applications where reflection of light needs to be minimized. To minimize reflection of light, diffuse coatings that minimize specular reflection have been used on relatively flat surfaces. These diffuse coatings scatter light in all directions, thereby minimizing the light reflected directly back from a flat surface to the eye of the beholder. However, the effectiveness of these coatings is inherently limited by the diffuse reflectance of the coating itself.

There are times when a surface is needed that absorbs more light than is possible using a simple diffuse coating on a flat surface. For example, diffusely coated models need a background that is blacker than the model itself in order to obtain a contrast with the model. Many other applications would benefit from a light-absorbing surface that absorbs more light than is possible with diffuse coatings alone. Much research has been done with the desired goal of reducing the diffuse reflectance of various coatings. Little research has been done to search for alternative structures and methods for trapping light within a light-absorbing surface.

### DISCLOSURE OF INVENTION

According to the preferred embodiments, a light-absorbing surface includes an array of elongated channels with openings at their proximal ends that face the light. These elongated channels may be straight, may include an angled portion, and may include two or more angled portions. The elongated channels may be suitably terminated at their distal end to further aid in absorbing light energy. The elongated channels may also be coated in a suitable coating that increases the specular reflectance of the elongated channels. The elongated channels act as specular reflector tubes that attenuate the light energy that enters in their proximal end with each bounce inside the channels. The result is a light-absorbing surface that absorbs almost all of the light directed at the light-absorbing surface. The elongated channels may also allow air flow through the light-absorbing surface.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIGS. 1-6 each show different cross-sectional end views of light-absorbing surfaces within the scope of the preferred embodiments;

FIG. 7 is a table showing effective reflectance of a hexagonal honeycomb structure given shown values for wall thickness and coating thickness;

FIG. 8A is a longitudinal cross-sectional view of an elongated channel showing specular reflection of light within the channel;

FIG. 8B is a longitudinal cross-sectional view of an elongated channel showing diffuse reflection of light within the channel;

FIGS. 9-12 each show different longitudinal cross-sectional configurations for the elongated channels of the preferred embodiments;

FIGS. 13-17 each show different possible terminations for the elongated channels of the preferred embodiments;

FIG. 18 is a perspective view of the angled channel configuration shown in FIG. 10 when multiple channels are bundled into a honeycomb configuration;

FIG. 19 is a perspective view showing an angled channel configuration similar to that shown in FIG. 18 with a gap between the straight portion and the angled portion;

FIG. 20 is a partial longitudinal cross-sectional view of the angle channel configuration shown in FIG. 18;

FIG. 21 is a perspective view of the angled channel configuration shown in FIG. 11 when multiple channels are bundled into a honeycomb configuration;

FIG. 22 is a perspective view of the angled channel configuration shown in FIG. 12 when multiple channels are bundled into a honeycomb configuration;

FIG. 23 is a flow diagram of a first method in accordance with the preferred embodiments for manufacturing a light-absorbing surface;

FIG. 24 is a flow diagram of a second method in accordance with the preferred embodiments for manufacturing a light-absorbing surface;

FIG. 25 is a flow diagram of a third method in accordance with the preferred embodiments for manufacturing a light-absorbing surface;

FIG. 26 is a flow diagram that shows one possible additional step for methods 2300, 2400 and 2500 in FIGS. 23-25;

FIG. 27 is a flow diagram that shows two possible additional steps for methods 2300, 2400 and 2500 in FIGS. 23-25;

FIG. 28 is a flow diagram of a first method for forming a honeycomb structure in accordance with the preferred embodiments; and

FIG. 29 is a flow diagram of a second method for forming a honeycomb structure in accordance with the preferred embodiments.

### BEST MODE FOR CARRYING OUT THE INVENTION

One known way to make a surface more absorptive to light energy is to paint the surface with a diffuse paint that is designed to maximize light diffusion. Flat black paints have been used to provide a diffuse coating on a surface. Even the blackest commercially-available paint may have a reflection coefficient that is too high for some applications, such as providing a background against which a black model is viewed. Black felt has also been used to absorb light energy. Other ways of making a surface more absorptive to light energy include micro-structured surface pits and complex dark flocking. These solutions can be very vulnerable to mechanical damage, oils, dirt, and other environmental elements. The preferred embodiments provide a light-absorbing surface that includes a mechanical structure with elongated channels that trap far more light that with known methods. The interior surfaces of the elongated channels may include a coating that improves the specular reflectance of the interior surfaces. As a result, the light-absorbing surface of the preferred embodiments provides a surface that appears darker than the blackest known paint, flocking, felt, or other known light-absorbing surface.

The light-absorbing surface in accordance with the preferred embodiments uses a plurality of elongated channels that effectively “trap” light that enters the channel, and absorbs the light at each specular reflection until most of the light energy is absorbed. the interior of the elongated channels are preferably coated with a coating that increases the specular reflection within the elongated channels. As a result of multiple reflections, during which each reflection absorbs more energy from whatever light might have remained after the previous reflection, the energy of the light entering the elongated channels is steadily reduced as the light specularly reflects along their length. Accordingly, the observer sees the light-absorbing surface of the preferred embodiments as an area that is darker than the coating used to coat the interior portions of the elongated channels. As a result, the light-absorbing surface appears much more black than other known surfaces in the art, and achieves a coefficient of reflection that is considerably less than the coefficient of reflection of the coating used to coat the interior of the elongated channels.

Note that the term “light-absorbing surface” as used in the specification and claims herein is not simply a thin, surficial covering, such as a coating of diffuse paint or black flocking. The term “light-absorbing surface” includes a structure that includes the elongated channels of the preferred embodiments. Such a structure necessarily has depth by virtue of the length of the elongated channels. For this reason, the term “light-absorbing surface” as used herein expressly includes a three-dimensional surface that includes the elongated channels of the preferred embodiments.

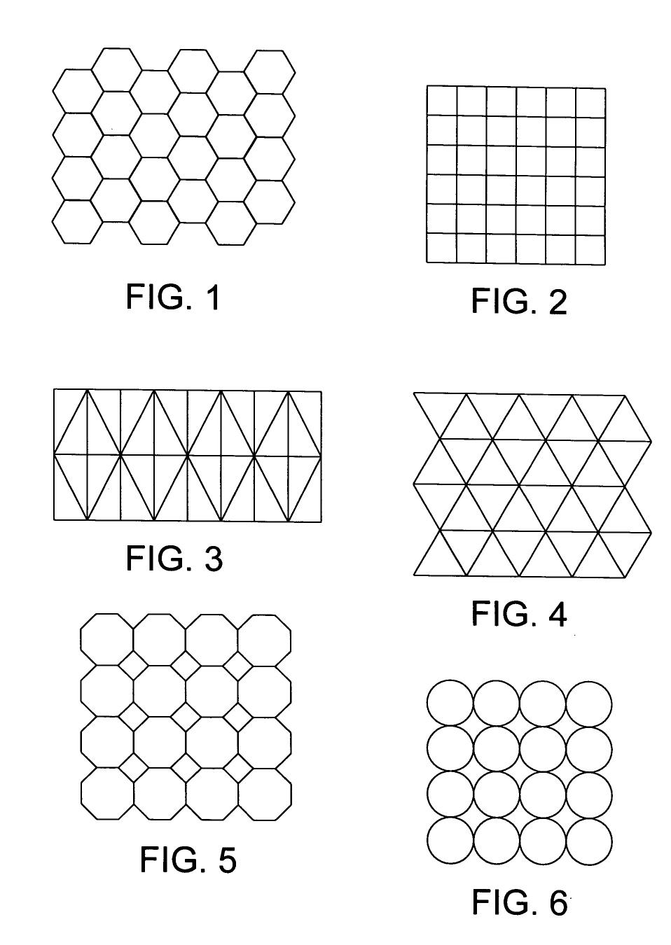

The elongated channels may have any suitable geometric cross-section, including combinations of different geometries. Examples of suitable geometries are shown in FIGS. 1-6. In FIG. 1, the elongated channels have a substantially hexagonal cross-section. In FIG. 2, the elongated channels have a substantially square cross-section. In FIG. 3, the elongated channels have a substantially triangular cross-section, with each triangle comprising a right triangle. In FIG. 4, the elongated channels have a substantially triangular cross-section, with each triangle comprising an equilateral triangle. In FIG. 5, two different geometries are present in the same group of channels, namely: octagons and squares. This combination of geometries may be created by joining together octagonal channels together, with the square channels resulting in the spaces between octagonal channels. In FIG. 6, two different geometries are present in the same group of channels, namely: circles, and spaces between the circles. This combination of geometries could be created by joining together circular channels, thereby creating the resulting spaces between circular channels. Rectangular channels are also within the scope of the preferred embodiments. For example, removing the diagonal lines in FIG. 3 would produce elongated channels with a rectangular cross-section.

The various different geometries shown in FIGS. 1-6 are shown as examples of suitable shapes and shape combinations that are within the scope of the preferred embodiments. The preferred embodiments expressly extend to any and all suitable geometric shapes and combinations that could be used to create a plurality of elongated channels.

The elongated channels in the preferred embodiments preferably have a very small ratio of wall thickness to opening size at the proximal end. The smaller this ratio, the better the performance of the light-absorbing surface. This is because the end walls have the possibility of producing single-bounce returns. By minimizing the wall thickness of the elongated channels, the amount of light that is directly reflected off the end walls is minimized.

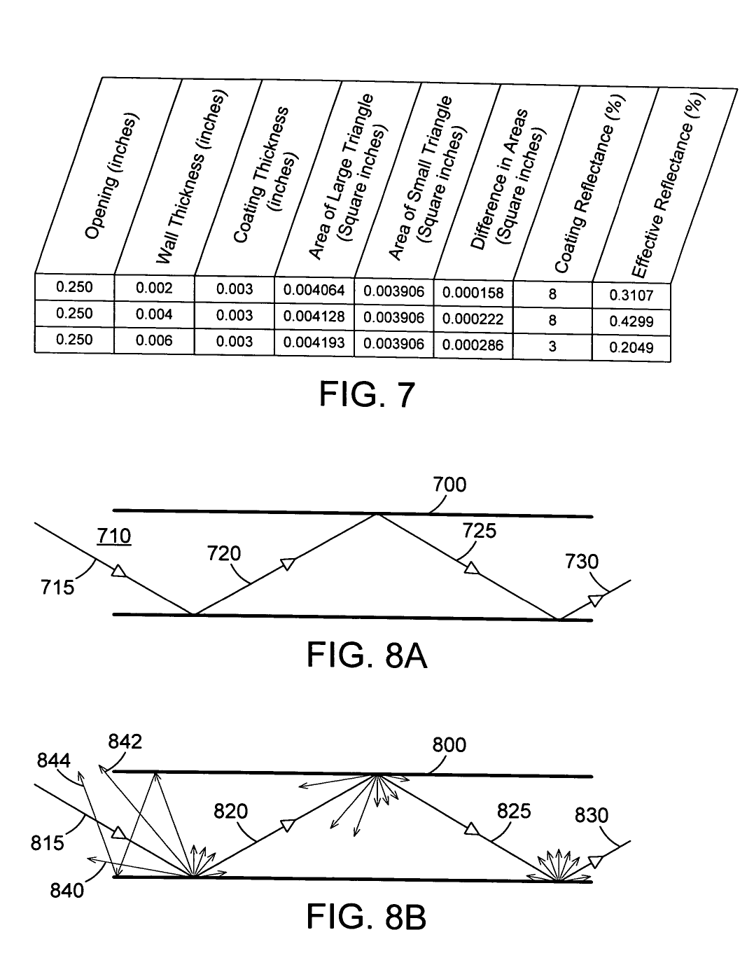

Referring to FIG. 7, a table 700 shows values used in computing effective reflectance of a hexagonal honeycomb structure (such as that shown in FIG. 1) that has an opening size of 0.25 inch (6.4 mm). A hexagon can be divided into 12 smaller triangles with 30/60/90 degree angles. We can compute the area of one of the triangles including the thickness of the wall and coating. We then compute the area of the triangle excluding the coating. The difference is the area of the wall, which we can ratio to the total area. We multiply this ratio times the coating reflectance to obtain the effective reflectance of the surface. The first entry in the table has a wall thickness of 0.002 inch (0.051 mm), a coating thickness of 0.003 inch (0.076 mm), and a coating reflectance of 8%. The resulting effective reflectance is 0.3107%. The second entry in the table has a wall thickness of 0.004 inch (0.10 mm), a coating thickness of 0.003 inch (0.076 mm), and a coating reflectance of 8%. The resulting effective reflectance is 0.4299%. The third entry in the table has a wall thickness of 0.006 inch (0.15 mm), a coating thickness of 0.003 inch (0.076 mm), but the coating reflectance is only 3%. The resulting effective reflectance is 0.2049%. This table shows how varying the wall thickness and coating reflectance affects the effective reflectance of the light-absorbing surface. As this table clearly shows, the thinner the walls of the elongated channels, the thinner the coating used to coat the channel walls, and the lower the reflectance of the coating used to coat the walls, the lower the effective reflectance of the light-absorbing surface will be. We see that the preferred embodiments use a combination of mechanical structure (elongated channels) with a coating that improves specular reflectance within the elongated channels to thereby produce a light-absorbing surface that has a reflectance much less than the reflectance of the light-absorbing coating itself. Note that some materials may be used that have good enough specular reflectance that no coating is required, which allow thinner channel walls in the absence of the coating.

In the preferred embodiments, the edge of the elongated channels at the proximal end (that faces the light) is preferably in a plane that is normal to a longitudinal axis of the elongated channel. This configuration minimizes the number of single-bounce reflections from the light source that occur due to the edges of the proximal end. Note also that the edges of the proximal end are preferably flat, but could also be formed in an angled or rounded configuration within the scope of the preferred embodiments.

In the preferred embodiments, the inside portion of the elongated channels is preferably coated with a suitable coating that increases the specular reflectance of the elongated channels. Specular reflection of light within an elongated channel is shown in FIG. 8A. Black gloss-finish enamel paint is one example of a suitable coating that provides good specular reflection. In this example, light that enters a proximal end 710 of channel 700 produces specular reflection off the walls of the channel, resulting in the light reflecting farther down the channel 700. With each reflection, the energy of the reflected light is further reduced. Thus, the energy in the incoming light 715 is greater than the energy in the first reflection 720, which is greater than the energy of the second reflection 725, which is greater than the energy of the third reflection 730, and so on. If enough reflections are made, the energy of the reflected light may be almost completed absorbed. As a result, the elongated channel 700 appears to “trap” the light that enters into it.

Assuming the elongated channel 700 is coated with a coating that has a specular reflectance of 15%, it has been found that the first reflection 720 only has 15.0% of the energy of the incoming light 715. The second reflection 725 has 2.25% of the energy of the incoming light 715. The third reflection 730 has 0.33% of the energy of the incoming light 715. A fourth reflection (not shown in FIG. 8A) would have 0.05% of the energy of the incoming light 715, and a fifth reflection (also not shown in FIG. 8A) would have 0.01% of the energy of the incoming light 715. We see from this simple example that three reflections takes the energy of the incoming light down to 0.33%, while five reflections takes the energy of the incoming light to less than 0.01%. For this reason, it is preferred to provide elongated channels that provide at least three reflections, and preferably five reflections, within the elongated channel 700.

Contrast the specular reflection shown in FIG. 8A with the case of diffuse reflection shown in FIG. 8B. In the case of diffuse reflection, the light 815 that enters the elongated channel 800 is reflected in a diffuse manner in all directions. As a result, some of the light 815 that enters the channel 800 is reflected directly back out the channel 800, as shown at 840 and 842. In addition, some of the light may be reflected back off the sides of the channel 800 before it exits the channel, as shown at 844. Other reflections such as 820 also produce a diffuse reflection, resulting in more light that may exit the elongated channel 800 with a small number of reflections, thereby allowing such reflections to reflect light energy out of the same end of the elongated channel 800 that the light entered.

While the coating used to coat the inside of the elongated channels preferably provides specular reflection as shown in FIG. 7, as the ratio of the length of the elongated channel 700 to the width of the proximal opening 710 increases, the incident angle of light that may enter the elongated channel 700 is reduced. It has been found that even diffuse coatings produce good specular reflection at high incident (i.e., grazing) angles. Thus, while a coating that is designed to maximize specular reflection shown in FIG. 7 is preferred, a coating that provides diffuse reflection as shown in FIG. 8B may also be used within the scope of the preferred embodiments.

One of the significant features of the preferred embodiments is the desire to maximize specular reflection within the elongated channels. Over the years, wisdom in the art has said a glossy surface is desirable when a highly reflective surface is desired, and a flat (or diffuse) surface is desirable when a surface that absorbs light is desired. One of the keys of the present invention is the use of specular reflection within the elongated channels to attenuate the energy of the light that enters the channels. This is counter-intuitive to those skilled in the art, because a diffuse coating is typically used when light absorption is desired. However, the combination of the elongated channels and their interior walls that provide for specular reflection results in near-complete light absorption using a specular coating. Because each successive reflection loses energy, the elongated channels absorb nearly all of the light that enters the channels by maximizing the specular reflection within the channels.

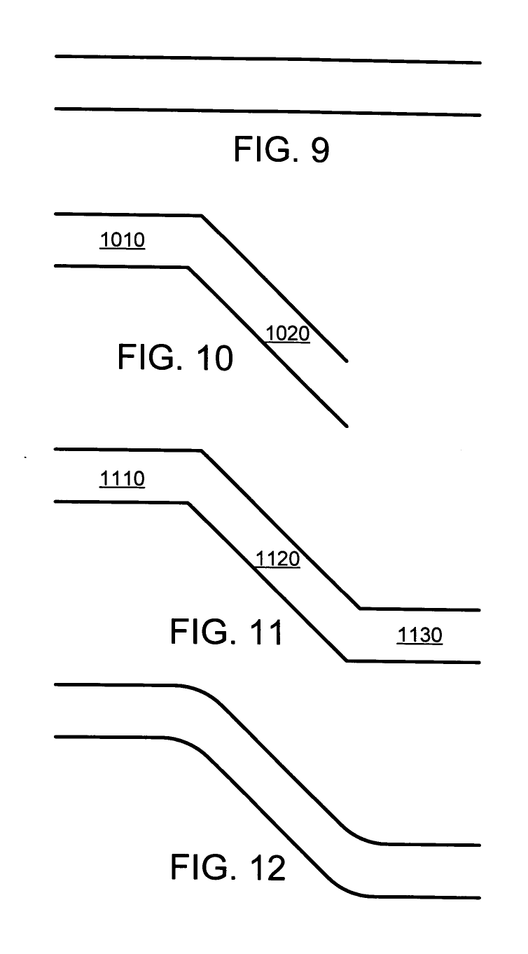

The elongated channels of the preferred embodiments may have a number of different configurations. For example, the elongated channels could be substantially straight, as shown in FIG. 9. The elongated channels could have a first section 1010 that is coupled at an angle to a second section 1020, as shown in FIG. 10. The elongated channels could have a first section 1110 that is coupled at an angle to a second section 1120, which is, in turn, coupled at an angle to a third section 1130, as shown in FIG. 11. In addition, the surfaces could be curved, as shown in FIG. 12, which is similar to the configuration in FIG. 11 with smooth curves instead of straight-line angles. The configuration in FIG. 9 works reasonably well if the length of the elongated channel is long enough to assure a sufficient number of reflections in most cases. An advantage of the configurations in FIGS. 10-12 is that the angled portions produce additional reflections in a shorter length, allowing the thickness of the light-absorbing surface to be reduced.

One significant advantage of all of the configurations shown in FIGS. 9-12 is they can be open on both ends, thereby allowing free flow of fluid or gas through the light-absorbing surface. The preferred embodiments thus provide a surface that does not allow light to pass, but allows air to easily pass. One suitable use for such a surface would be in the construction of a free-standing dark room inside a home or business. A dark room could be constructed using the light-absorbing surface as the side walls and ceiling. Such a configuration would prevent any of the light from outside the darkroom from entering into the darkroom, but would allow air flow from heat and air conditioning to easily pass through the porous walls and ceiling of the darkroom. The preferred embodiments thus provide a new and useful surface that is both light-absorbing and porous. The ability to block light energy while allowing free passage of air, gas, or other substances creates a unique surface that is not known in the art.

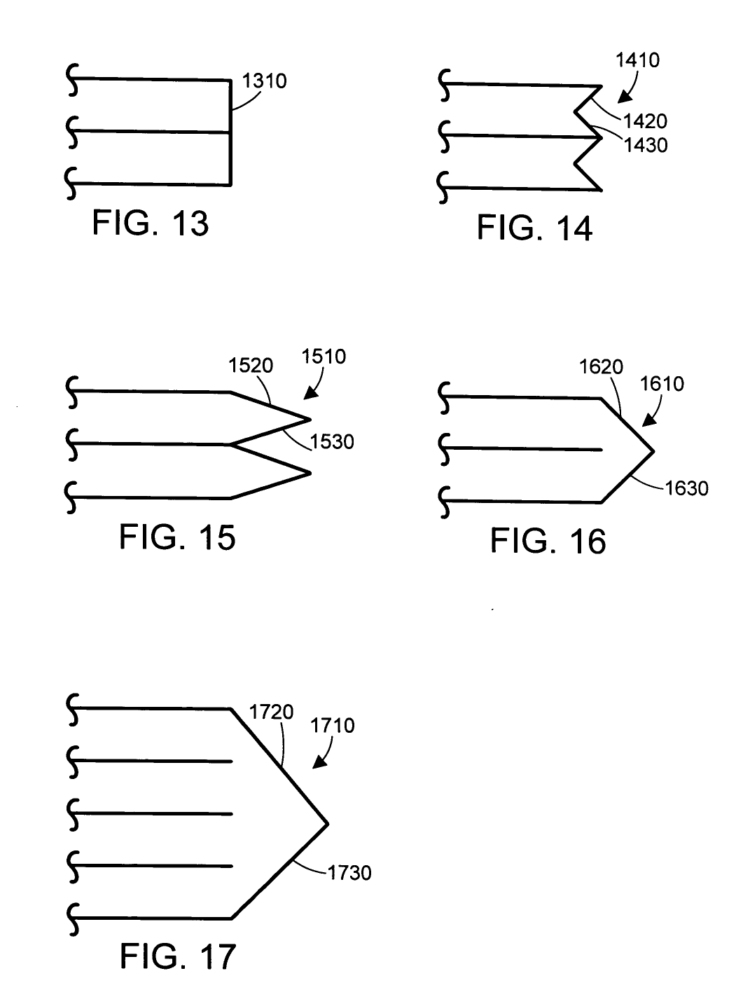

The performance of the elongated channels of the preferred embodiments may be enhanced by providing suitable terminations at the distal end of the elongated channels (the end away from the light source). FIGS. 13-17 show various different configurations for terminations within the scope of the preferred embodiments. FIG. 13 shows the use of a flat wall termination 1310. FIG. 14 shows an angled wall termination 1410 that preferably includes a first angled portion 1420 coupled to a second angled portion 1430. Note that the configuration shown in FIG. 14 could represent an angled groove terminator, a pyramidal terminator, or a conical terminator. FIG. 15 shows an angled terminator 1510 that includes a first angled portion 1520 and a second angled portion 1530. FIG. 16 shows an angled terminator 1610 that includes a first angled portion 1620 and a second angled portion 1630. Note that terminator 1610 in FIG. 16 spans multiple elongated channels. FIG. 17 shows an angled terminator 1710 that includes a first angled portion 1720 and a second angled portion 1730 that spans many elongated channels. All of the terminators shown in FIGS. 13-17 provide enhanced performance by providing a surface against which light reflects. By providing a terminator as shown in FIGS. 13-17, the length of the elongated channels may be reduced, because the light must now make additional reflections within the elongated channel after it strikes the terminator before it can escape out of the proximal opening of the elongated channel. Note that light from one channel may even be directed into a different channel after striking the terminator, as shown in the examples in FIGS. 16 and 17. Providing a terminator as shown in FIGS. 13-17 may produce better light-absorption performance with shorter elongated channels, but this improved performance comes at the expense of channels that are no longer permeable to fluid and gas. In many applications, permeability to fluid and gas is not a requirement. In such applications, terminators may be added to any of the configurations shown in FIGS. 9-12 (or other configurations not shown herein). Note, however, that is equally within the scope of the preferred embodiments to provide partial terminators, meaning that the terminators shown in FIGS. 13-17 could have openings that allow some flow of fluid or gas through the elongated channels while still improving the light absorption of the elongated channels.

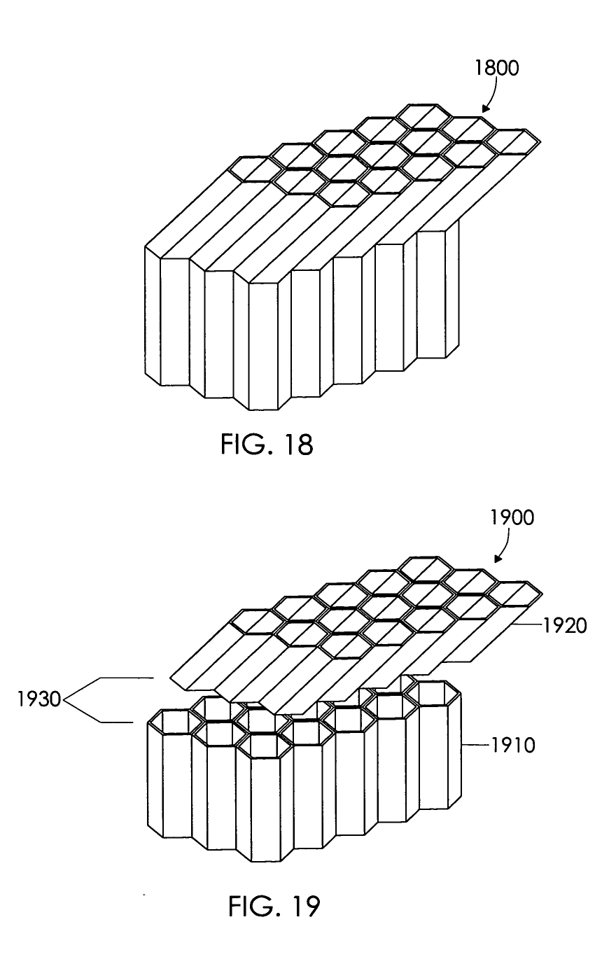

One sample configuration for the light-absorbing surface 1800 that is within the scope of the preferred embodiments is shown in FIG. 18. This configuration includes multiple elongated channels that each have a configuration similar to that shown in FIG. 10. For this specific configuration, the lower surface would preferably be placed toward the light source with the longitudinal axes of the lower, straight channels being substantially normal to the light source. In an alternative configuration, the upper face of the light-absorbing surface 1800 may be placed towards a light source. In this case, the beveled opening of the upper face would preferably be placed toward the light source with the longitudinal axes of the upper, angled channels being substantially normal to the light source. Note that the beveled edges of the upper surface in FIG. 18 may provide more single-bounce returns when viewed off-angle. As a result, the preferred placement of the light-absorbing surface 1800 is to have a proximal face (such as the bottom face in FIG. 18) that is in a plane normal to the longitudinal axes of the elongated channels facing the light source.

A variation of the configuration shown in FIG. 18 is shown in FIG. 19. The light-absorbing surface 1900 includes a first portion 1910 that is spaced apart from the second portion 1920 by a gap 1930. The gap 1930 may be used for a variety of different purposes. For example, a shutter could be placed in the gap. When the shutter is open, air could freely flow through the light-absorbing surface 1900. When the shutter is closed, such free air flow would be prevented. In addition, a collimated light source could be provided within the gap 1930. This would allow collimated light to be projected from the gap through the first portion 1910, while still allowing the second portion 1920 to absorb light from other sources. Because the light is collimated, it passes through the elongated channels without being significantly attenuated by reflections within the elongated channels.

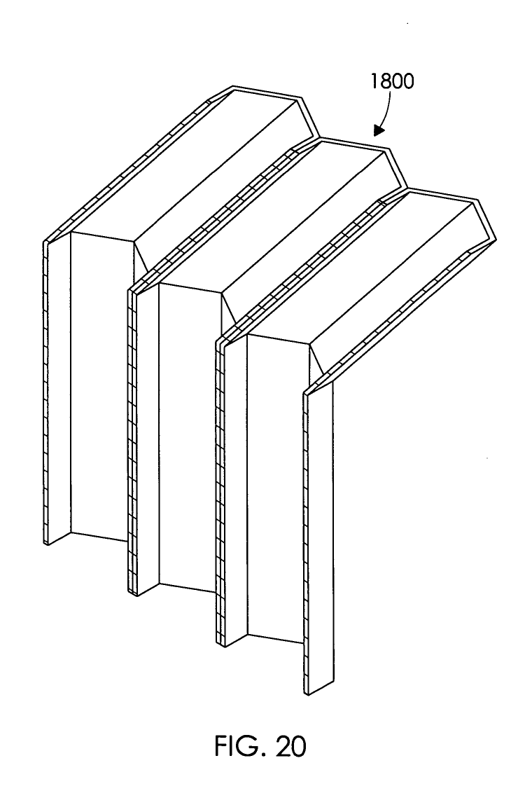

FIG. 20 shows a partial longitudinal cross-sectional view of the light-absorbing surface 1800 in FIG. 18. In the specific configuration shown in FIG. 20, the light-absorbing surface 1800 is made by attaching hexagonal channels together. The cross-sectional view in FIG. 20 shows that the elongated channels are preferably of uniform cross-section along their length, and have interior surfaces that either inherently provide good specular reflection, or that may be treated with a suitable coating to improve their specular reflection.

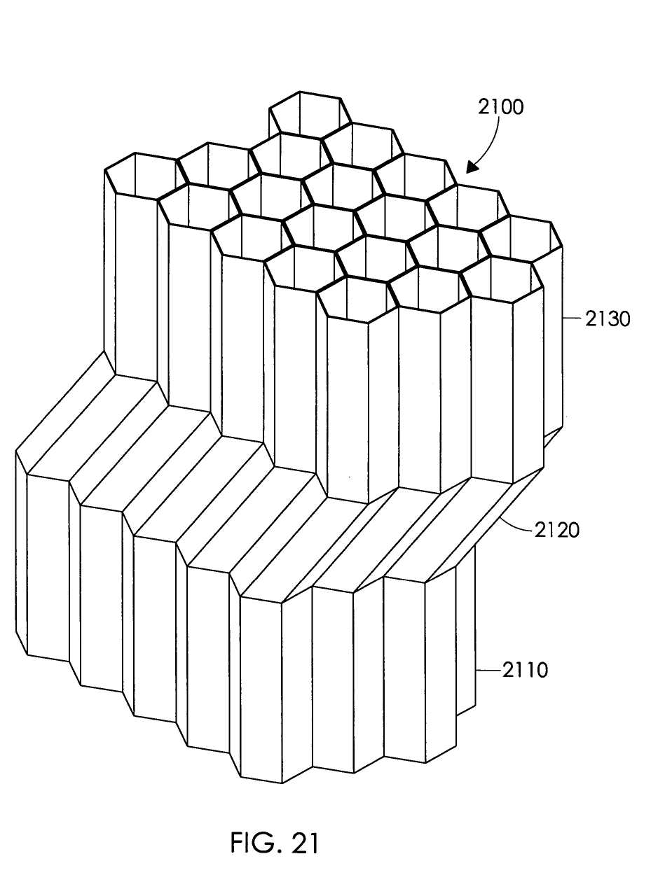

Another configuration in accordance with the preferred embodiments is shown as light-absorbing surface 2100 in FIG. 21. This configuration includes multiple elongated channels that each have a configuration similar to that shown in FIG. 11. Light-absorbing surface 2100 includes a first portion 2110 coupled at an angle to a second portion 2120, which is coupled at an angle to a third portion 2130. Providing multiple bends in the light-reflecting surface 2100 results in additional reflections within the elongated channels, thereby reducing the reflectance of the light-absorbing surface 2100.

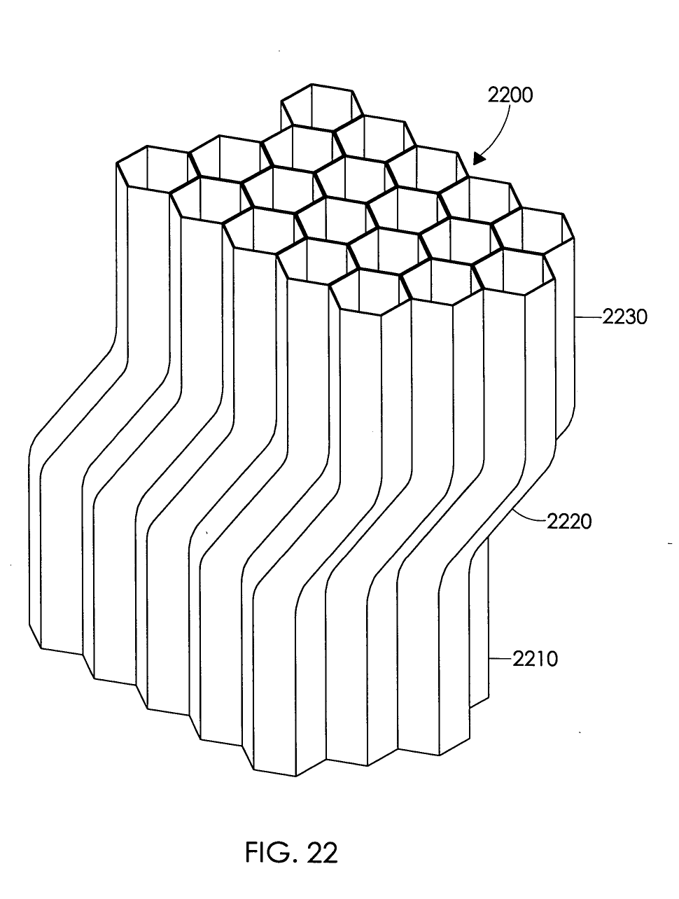

Yet another configuration in accordance with the preferred embodiments is shown as light-absorbing surface 2200 in FIG. 22. This configuration includes multiple elongated channels that each have a configuration similar to that shown in FIG. 12. Light-absorbing surface 2200 includes a first portion 2210 coupled at an angle to a second portion 2220, which is coupled at an angle to a third portion 2230. The primary difference between light-absorbing surface 2100 in FIG. 21 and surface 2200 in FIG. 22 is that the straight-line angles in FIG. 21 between sections 2110, 2120, and 2130 have been changed to smooth curves between sections 2210, 2220 and 2230 in surface 2200 in FIG. 22.

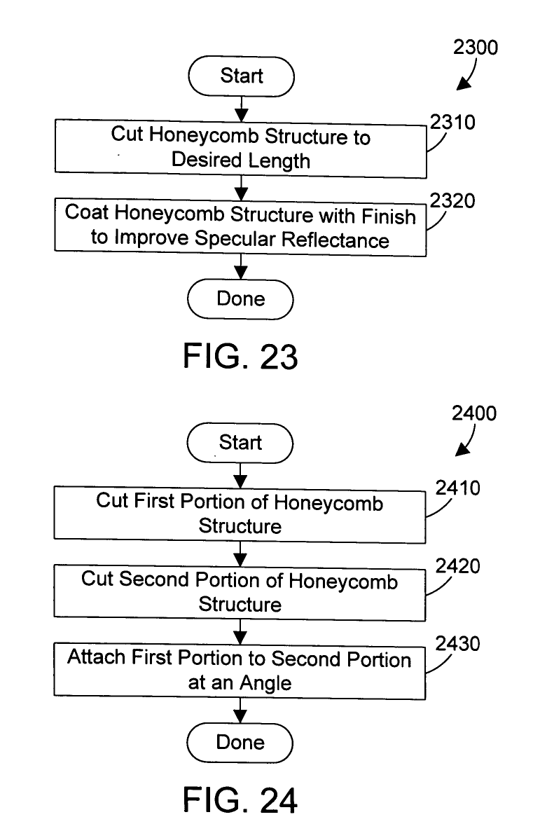

There are various different methods that could be used to manufacture a light-absorbing surface in accordance with the preferred embodiments. One example method 2300 is shown in FIG. 23. First, a honeycomb structure is cut to a desired length (step 2310). The term “honeycomb structure” is used herein in a broad sense to represent any group of adjacent elongated channels, regardless of their specific geometric cross-section. Thus, a “honeycomb structure” as used herein is not limited to the traditional hexagonal shape of a real honeycomb in a beehive. Next, the honeycomb structure is coated with a finish that improves the specular reflectance of the elongated channels (step 2320). A gloss black enamel paint is one suitable coating, and the honeycomb structure could be coated in step 2320 by dipping the honeycomb structure into the paint, then lifting the honeycomb structure out of the paint with the elongated channels oriented in a vertical direction to allow the excess paint to flow out of the elongated channels, and allowing the paint to dry. The viscosity and adhesive forces of the paint cause any minute defects in the honeycomb surface to fill with paint, making the surface smoother and accordingly more specular. More than one dip-and-dry cycle may be needed to achieve maximum levels of specularity.

Various forms of honeycomb structures could be used within the scope of the preferred embodiments. For example, aluminum, polymer, and paper core honeycomb structures are available from Hexcel Corporation at 281 Tresser Blvd., Two Stamford Place, Stamford, Conn., 06901. These honeycomb structures typically have a specular reflectance that is not sufficiently high for optimum performance, and thus require the coating step 2320 in method 2300.

One suitable honeycomb structure that may be used in the preferred embodiments is a group of black polypropylene straws that are held together. Such a honeycomb structure of black polypropylene is commercially-available from Plascore, Inc. at 615N Fairview St., Zeeland, Mich., 49464. The black polypropylene from Plascore, Inc. has sufficient specular reflectance that it may be used directly, without the need for coating the interior of the elongated channels. Of course, improved performance could be achieved by adding a coating that improves the specular performance of the elongated channels even more.

The commercially-available honeycomb structures have been used in a variety of different applications, typically as lightweight structural components. A honeycomb structure provides great strength at a relatively low weight. For this reason, these types of honeycomb structures have been used where lightweight but strong structural members are needed.

Referring to FIG. 24, a method 2400 in accordance with the preferred embodiments begins by cutting a first portion of honeycomb structure (step 2410). Next, a second portion of honeycomb structure is cut (step 2420). Finally, the first portion and second portion are attached at an angle (step 2430). Method 2400 could be used, for example, to generate the angled configuration 1800 shown in FIG. 18. Of course, in addition to the steps shown in FIG. 24, a third portion of honeycomb structure could be cut and attached to one of the previous two sections, resulting in the configuration 2100 shown in FIG. 21.

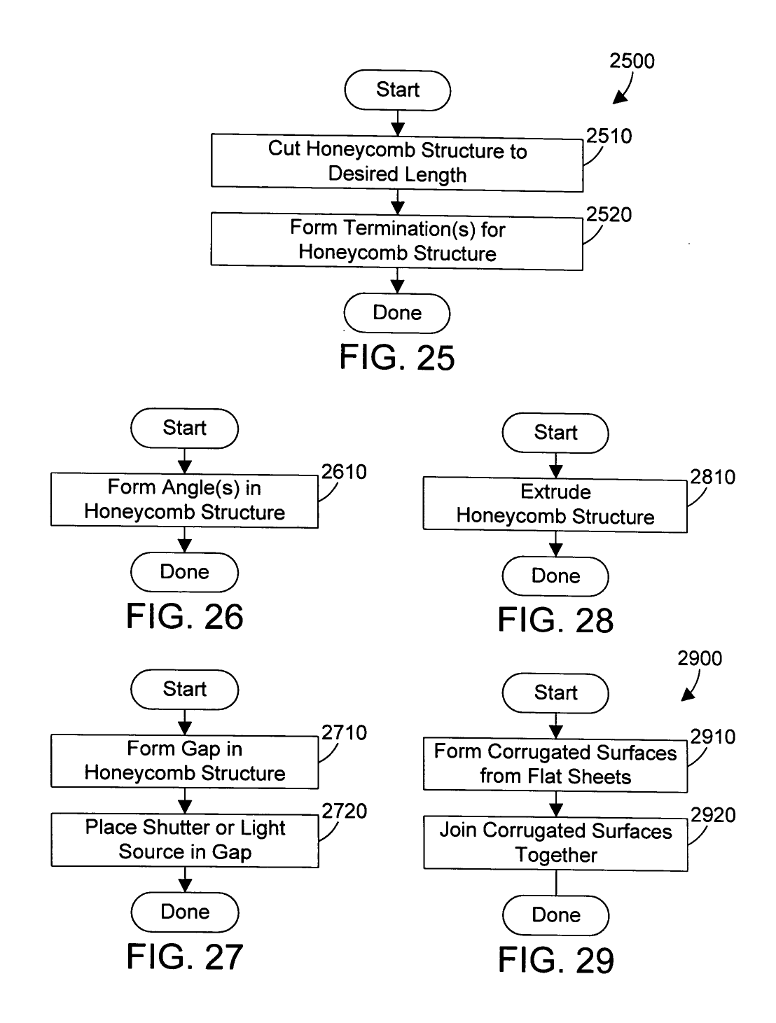

FIG. 25 shows another method 2500 for forming a light-absorbing surface in accordance with the preferred embodiments. First, a honeycomb structure is cut to a desired length (step 2510). One or more terminations are then formed for the honeycomb structure (step 2520). Sample terminations within the scope of the preferred embodiments are shown in FIGS. 13-17. Of course, other terminations not shown in the figures are also within the scope of the preferred embodiments.

Note that some of the steps in methods 2300, 2400, and 2500 in FIGS. 23-25, respectively, could be performed in the other methods as well. For example, the step of coating the elongated channels with a finish in step 2330 could be performed in method 2400 and method 2500 as well. The steps in method 2400 of forming attached angled portions could be performed as part of method 2300 or method 2500. The formation of terminations in step 2520 could also be performed as part of method 2300 or method 2400. These methods 2300, 2400, and 2500 are shown as simple examples of some method steps that could be performed within the scope of the preferred embodiments, and one skilled in the art will recognize that these steps could be combined as needed to achieve a particular structure for the light-absorbing surface.

Additional steps could also be performed during any of methods 2300, 2400, and 2500. For example, step 2610 in FIG. 26 forms angles in the honeycomb structure. Method 2400 in FIG. 24 shows one specific way for forming an angle. However, an angle could also be produced in other suitable ways. For example, the curved structure 2200 in FIG. 22 could be achieved by heating the structure to a point of softening the material, then exerting a shear force on part of the structure while maintaining the position of the other part of the structure, resulting in a bend in the elongated channels, as shown in FIG. 22. The honeycomb structure of the preferred embodiments could be suitably reshaped via thermal or mechanical means. Any suitable method may be used to create one or more angles or curved surfaces in the elongated channels within the scope of step 2610 in FIG. 26.

Referring to FIG. 27, other steps that could be performed during any of methods 2300, 2400, and 2500 include the steps of forming a gap in the honeycomb structure (step 2710), and placing a shutter or light source in the gap (step 2720). As stated above, the various method steps in FIGS. 23-27 could be combined in any suitable manner within the scope of the preferred embodiments to achieve a desired configuration for a light-absorbing surface.

Referring to FIG. 28, one way to form the honeycomb structure of the preferred embodiments is via extrusion (step 2810). Another way to form the honeycomb structure of the preferred embodiments is shown as method 2900 in FIG. 29. First, corrugated surfaces are formed from flat sheets of material (step 2910). Next, multiple corrugated surfaces are joined together (step 2920). The corrugations form the elongated channels. This process may be repeated as needed to form a stack of corrugated channels of any suitable height.

One advantage of forming the honeycomb structure from sheets that make a corrugated structure is the ability to provide a desired profile to the edge at the proximal end of the elongated channels. For example, a sloped, chisel-like edge could be provided on one edge of the flat sheets used to form the corrugations. Once formed up, the chisel-like edge of the proximal ends achieve an effectively smaller entry cross-section than the actual wall thickness cross-sections. As a result, the effective reflectance of the light-absorbing surface may be reduced. The proximal edge could also be shaped to a desired profile using a tool after the honeycomb structure is manufactured. The preferred embodiments expressly extend to any known method for providing a desired profile to the edge of the elongated channels in the honeycomb structure at their proximal end.

Referring back to FIG. 8A, in the preferred embodiments, the length of the elongated channel 700 is substantially longer than the width of the opening at its proximal end 710 that faces the light. For the specific example of a hexagonal honeycomb structure with 0.25 inch (6.4 mm) openings, assuming a mean specular reflectance of 15% for the interior of the honeycomb structure by coating the honeycomb structure with a coating with a specular reflectance of 15%, assuming a combined wall and coating thickness of 0.008 inch (0.20 mm), and assuming we want to have at least 99% of the hemisphere in front of the light-absorbing surface to demonstrate a reflectance less than 1%, the following length to width ratios will provide the desired performance: 50:1 for straight elongated channels without terminations; 10:1 for 1 bend without terminations; 5:1 for 2 bends without terminations; 10:1 for straight elongated channels with terminations; 5:1 for 1 bend with terminations; and 3:1 for 2 bends with terminations. These numbers are provided as examples of a best mode for the hexagonal honeycomb structure with 0.25 inch (6.4 mm) openings. One skilled in the art will recognize that similar ratios could be mathematically derived for any suitable opening size and geometric cross-section.

The light-absorbing surface of the preferred embodiments have a variety of different applications. As described above, the light-absorbing surface could be used to fabricate wall panels for a stand-alone darkroom. Ceiling tiles that totally absorb light could be fabricated from this light-absorbing surface. Walls or ceilings of indoor rides at amusement parks that need to be dark could be lined with this light-absorbing surface. Anti-glare backgrounds for sports stadiums could also use this light-absorbing surface. The inside walls of movie theaters could also use this light-absorbing surface. Each of these above-mentioned applications are used in a lit room to give the appearance of a black surface within the room. But the light-absorbing surface of the preferred embodiments can also be used to absorb light shining on one side from passing through to the other side. For example, the military uses of the light-absorbing surface could be numerous. An aircraft hanger could be fully-lit inside to allow for repairing aircraft even during the night. The light-absorbing surface could be used to trap the light in the hanger, thereby preventing the light from escaping outside of the hanger. In this manner, an aircraft hanger could remain invisible to enemy aircraft, even though it is fully lit inside. And, using the non-terminated configuration, another interesting military application is the construction of temporary shelter for personnel so they can use lights and even light fires without being seen from above or any side. Two panels made of the light-absorbing surface could be hinged in a pup-tent configuration. Soldiers under the shelter could use lights without fear of the light being seen by the enemy. Smoke would pass right through the non-terminated elongated channels of the light-absorbing surface. As these examples above illustrate, the applications for using the light-absorbing surface of the preferred embodiments are varied and numerous. The preferred embodiments expressly extend to any suitable application or use of the light-absorbing surface disclosed herein.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, while the preferred embodiments herein refer to the absorption of light, one skilled in the art will recognize that light represents one form of energy that could be absorbed using the structure of the preferred embodiments. The preferred embodiments also extend to the absorption of any form of energy that can be fully or partially reflected specularly, including radio waves, sound waves, infrared waves, pressure waves, and other forms of energy.

1. A light-absorbing surface comprising:
a plurality of elongated channels; and
a coating on an interior portion of the plurality of elongated channels that improves specular reflectance of the interior portion.

2. The light-absorbing surface of claim 1 wherein the plurality of elongated channels have proximal ends disposed towards a light source.

3. The light-absorbing surface of claim 2 wherein the proximal end of at least one of the plurality of elongated channels has an edge that is shaped to a desired profile.

4. The light-absorbing surface of claim 2 wherein an edge surface of the proximal end of at least one elongated channel is in a plane that is substantially normal to a longitudinal axis of the elongated channel.

5. The light-absorbing surface of claim 1 wherein at least one of the plurality of elongated channels is substantially straight.

6. The light-absorbing surface of claim 1 wherein at least one of the plurality of elongated channels includes at least one first portion that is disposed at an angle to at least one second portion.

7. The light-absorbing surface of claim 1 wherein at least one of the plurality of elongated channels includes a curved surface.

8. The light-absorbing surface of claim 1 wherein at least one of the plurality of elongated channels includes a substantially closed termination at a distal end.

9. The light-absorbing surface of claim 8 wherein the termination comprises a substantially flat surface.

10. The light-absorbing surface of claim 8 wherein the termination comprises at least one angled surface.

11. The light-absorbing surface of claim 8 wherein the termination spans a plurality of the elongated channels.

12. The light-absorbing surface of claim 1 further comprising first and second portions that are separated by a gap.

13. The light-absorbing surface of claim 12 further comprising a shutter disposed in the gap.

14. The light-absorbing surface of claim 1 wherein the plurality of elongated channels are arranged in a honeycomb structure.

15. The light-absorbing surface of claim 1 wherein each elongated channel has a length substantially greater than a width of the elongated channel.

16. The light-absorbing surface of claim 15 wherein the length of an elongated channel is substantially greater than the width of the elongated channel.

17. The light-absorbing surface of claim 1 wherein the plurality of elongated channels allow flow of fluid and gas through the plurality of elongated channels.

18. The light-absorbing surface of claim 1 wherein each elongated channel has a substantially hexagonal cross section.

19. The light-absorbing surface of claim 1 wherein each elongated channel has a substantially square cross section.

20. The light-absorbing surface of claim 1 wherein each elongated channel has a substantially triangular cross section.

21. The light-absorbing surface of claim 1 wherein each elongated channel has a substantially rectangular cross section.

22. A light-absorbing surface comprising:
a honeycomb structure of elongated channels, each elongated channel having a length substantially greater than a width of the elongated channel; and
a coating on an interior portion of the elongated channels that improves specular reflectance of the interior portion.

23. The light-absorbing surface of claim 22 wherein at least one of the plurality of elongated channels is substantially straight.

24. The light-absorbing surface of claim 22 wherein at least one of the plurality of elongated channels includes at least one first portion that is disposed at an angle to at least one second portion.

25. The light-absorbing surface of claim 22 wherein at least one of the plurality of elongated channels includes a curved surface.

26. The light-absorbing surface of claim 22 wherein at least one of the plurality of elongated channels includes a substantially closed termination at a distal end.

27. The light-absorbing surface of claim 26 wherein the termination comprises a substantially flat surface.

28. The light-absorbing surface of claim 26 wherein the termination comprises at least one angled surface.

29. The light-absorbing surface of claim 26 wherein the termination spans a plurality of the elongated channels.

30. The light-absorbing surface of claim 22 further comprising first and second portions that are separated by a gap.

31. The light-absorbing surface of claim 30 further comprising a shutter disposed in the gap.

32. The light-absorbing surface of claim 22 wherein the length of an elongated channel is substantially greater than the width of the elongated channel.

33. The light-absorbing surface of claim 22 wherein the plurality of elongated channels allow flow of fluid and gas through the plurality of elongated channels.

34. The light-absorbing surface of claim 22 wherein each elongated channel in the honeycomb structure has a substantially hexagonal cross section.

35. The light-absorbing surface of claim 22 wherein each elongated channel in the honeycomb structure has a substantially square cross section.

36. The light-absorbing surface of claim 22 wherein each elongated channel in the honeycomb structure has a substantially triangular cross section.

37. The light-absorbing surface of claim 22 wherein each elongated channel in the honeycomb structure has a substantially rectangular cross section.

38. A light-absorbing surface comprising:
a first plurality of elongated channels; and
a second plurality of elongated channels disposed at an angle to the first plurality of elongated channels.

39. The light-absorbing surface of claim 38 wherein the plurality of elongated channels allow flow of fluid and gas through the plurality of elongated channels.

40. The light-absorbing surface of claim 38 wherein each elongated channel has a substantially hexagonal cross section.

41. The light-absorbing surface of claim 38 wherein each elongated channel has a substantially square cross section.

42. The light-absorbing surface of claim 38 wherein each elongated channel has a substantially triangular cross section.

43. The light-absorbing surface of claim 38 wherein each elongated channel has a substantially rectangular cross section.

44. A light-absorbing surface comprising:
a plurality of elongated channels, each channel having a substantially open proximal end and a distal end, wherein at least one of the plurality of elongated channels includes a substantially closed termination at the distal end.

45. The light-absorbing surface of claim 44 wherein the proximal end of at least one of the plurality of elongated channels has an edge that is shaped to a desired profile.

46. The light-absorbing surface of claim 44 wherein the termination comprises a substantially flat surface.

47. The light-absorbing surface of claim 44 wherein the termination comprises at least one angled surface.

48. The light-absorbing surface of claim 44 wherein the termination spans a plurality of the elongated channels.

49. The light-absorbing surface of claim 44 wherein the plurality of elongated channels are arranged in a honeycomb structure.

50. The light-absorbing surface of claim 44 wherein each elongated channel has a substantially hexagonal cross section.

51. The light-absorbing surface of claim 44 wherein each elongated channel has a substantially square cross section.

52. The light-absorbing surface of claim 44 wherein each elongated channel has a substantially triangular cross section.

53. The light-absorbing surface of claim 44 wherein each elongated channel has a substantially rectangular cross section.

54. A surface for absorbing light from a light source, the surface comprising:
a plurality of elongated channels having proximal ends disposed towards the light source, wherein a length of the plurality of elongated channels allows a majority of light from the light source that enters one of the plurality of elongated channels to specularly reflect at least three times before the light exits the plurality of elongated channels.

55. The surface of claim 54 further comprising:
a light-absorbing coating on an interior portion of the plurality of elongated channels.

56. The surface of claim 54 wherein the length of the plurality of elongated channels allows a majority of light from the light source that enters one of the plurality of elongated channels to specularly reflect at least five time before the light exits the plurality of elongated channels.

57. A method for manufacturing a light-absorbing surface comprising the steps of:
cutting a honeycomb structure of elongated channels to a desired length; and
treating the honeycomb structure of elongated channels with a coating that improves specular reflectance of the elongated channels.

58. The method of claim 57 further comprising the step of forming at least one substantially closed termination for at least one elongated channel.

59. The method of claim 58 wherein the termination comprises a substantially flat surface.

60. The method of claim 58 wherein the termination comprises at least one angled surface.

61. The method of claim 58 wherein the termination spans a plurality of the elongated channels.

62. The method of claim 57 further comprising the step of forming at least one angle fain at least one elongated channel.

63. The method of claim 57 further comprising the step of shaping a proximal edge of the honeycomb structure.

64. The method of claim 57 further comprising the step of forming a gap in the honeycomb structure.

65. The method of claim 64 further comprising the step of placing a shutter within the gap of the honeycomb structure.

66. The method of claim 64 further comprising the step of generating the honeycomb structure of elongated channels.

67. The method of claim 66 wherein the step of generating the honeycomb structure of elongated channels comprises the step of extruding the honeycomb structure.

68. The method of claim 66 wherein the step of generating the honeycomb structure of elongated channels comprises the steps of:
forming flat sheets of material into a plurality of corrugated surfaces; and
joining the plurality of corrugated surfaces together.

69. The method of claim 66 wherein the step of treating the honeycomb structure of elongated channels with the coating that improves the specular reflectance of the elongated channels comprises the steps of:
dipping the honeycomb structure in a liquid that comprises the coating;
removing the honeycomb structure from the liquid; and
allowing the liquid on the honeycomb structure to dry.

70. A method for manufacturing a light-absorbing surface comprising the steps of:
generating a honeycomb structure of elongated channels; and
forming the honeycomb structure into first and second portions, wherein the first portion is disposed at an angle to the second portion.

71. The method of claim wherein 70 wherein the step of forming the honeycomb structure into first and second portions comprises the steps of:
cutting a first portion of the honeycomb structure to a first desired length;
cutting a second portion of the honeycomb structure to a second desired length; and
attaching the first portion to the second portions so that the first portion is disposed at an angle with respect to the second portion.

72. A method for manufacturing a light-absorbing surface comprising the steps of:
cutting a honeycomb structure of elongated channels to a desired length; and
forming at least one substantially closed termination for at least one elongated channel.

73. The method of claim 72 wherein the termination comprises a substantially flat surface.

74. The method of claim 72 wherein the termination comprises at least one angled surface.

75. The method of claim 72 wherein the termination spans a plurality of the elongated channels.

76. A method for manufacturing a light-absorbing surface comprising the steps of:
forming flat sheets of material that have a relatively high specular reflectance into a plurality of corrugated surfaces; and
joining the plurality of corrugated surfaces together to form a plurality of elongated channels.

77. A method for manufacturing a light-absorbing surface comprising the steps of:
forming flat sheets of material into a plurality of corrugated surfaces;
joining the plurality of corrugated surfaces together to form a plurality of elongated channels; and
treating the elongated channels with a coating that improves specular reflectance of the elongated channels.
